(19) United States
(12) Patent Application Publication
(10) Pub. No.: US 2020/0313771 A1
(43) Pub. Date: Oct. 1, 2020

(54) OPTICAL TRANSCEIVER AND METHOD FOR MONITORING VARIATION IN POLARIZATION

(71) Applicant: FUJITSU LIMITED, Kawasaki-shi (JP)

(72) Inventor: Hisao Nakashima, Kawasaki (JP)

(73) Assignee: FUJITSU LIMITED, Kawasaki-shi (JP)

(21) Appl. No.: 16/834,017

(22) Filed: Mar. 30, 2020

(30) Foreign Application Priority Data
Apr. 1, 2019 (JP) 2019-070115

(51) Int. Cl. H04B 10/2507; H04B 10/079; H04J 14/06; H04B 10/40

(52) U.S. Cl. CPC H04B 10/2572; H04B 10/40; H04J 14/06; H04B 10/0799

(57) ABSTRACT

An optical transceiver includes: a receiver and a processor. The receiver receives a polarization multiplexed optical signal that includes a first polarization signal and a second polarization signal so as to output reception electric-field information that indicates an electric field of the polarization multiplexed optical signal. The processor calculates, according to the reception electric-field information, a variation monitor value that indicates an amount of leakage of signal components between the first polarization signal and the second polarization signal. When the variation monitor value exceeds a specified threshold, the processor analyzes, according to the reception electric-field information, a state of an optical transmission line through which the polarization multiplexed optical signal propagates.

### CROSS-REFERENCE TO RELATED APPLICATION

This application is based upon and claims the benefit of priority of the prior Japanese Patent Application No. 2019-070115, filed on Apr. 1, 2019, the entire contents of which are incorporated herein by reference.

### FIELD

The embodiments discussed herein are related to an optical transceiver and a method for monitoring a variation in a polarization.

### BACKGROUND

In recent years, optical transmission/reception techniques relying on coherent detection and digital signal processing have been put into practical use as techniques for realizing large-capacity, long-distance transmissions. The coherent detection generates electric field information indicating a received optical signal by using local light. The digital signal processing performs a demodulation based on the electric field information generated by the coherent detection so as to decide symbols. The digital signal processing compensates for waveform distortions that occur in an optical fiber transmission line.

Polarization multiplexing has been put into practical use as another technique for realizing large-capacity transmissions. In polarization multiplexing, optical signals are transmitted using a pair of polarizations orthogonal to each other. However, the polarization state of the optical signal may vary in an optical fiber transmission line due to various factors. A variation in the polarization state deteriorates the quality of the polarization multiplexed optical signal. Thus, an optical transceiver for transmitting the polarization multiplexed optical signal preferably has a function for monitoring a variation in the polarization state and a function for compensating for the variation. Note that a variation in the polarization state of an optical signal or a variation in the polarization state in an optical transmission line may hereinafter be referred to as a “polarization variation”.

A proposed method is one for measuring characteristics that depend on the polarization state in an optical transmission line (e.g., Japanese Laid-open Patent Publication No. 2014-027467). A polarization-variation compensation device for compensating for the influence of a polarization variation has been proposed (e.g., Japanese Laid-open Patent Publication No. 2011-223185). A proposed method is one wherein a real-time coherent receiver detects the influence of an optical fiber transmission (e.g., F. Boitier et al, “Proactive Fiber Damage Detection in Real-time Coherent Receiver,” ECOC2017 Th.2.F.1).

The polarization states of optical signals having various properties may vary in an optical fiber transmission line. If the polarization state is slowly changed due to a temperature change, aging, or the like, the optical transceiver can easily monitor and compensate for the polarization variation. However, the frequency of occurrence of a fast polarization variation (i.e., a phenomenon wherein the state of a polarization in an optical fiber transmission line instantly changes) is low, and it is difficult to compensate for such a variation. A high-speed processing circuit is needed to monitor fast polarization variations, thereby leading to a concern about an increase in the circuit size and/or power consumption. A fast polarization variation may occur due to, for example, a lighting strike, strong wind, or ground vibrations.

### SUMMARY

According to an aspect of the embodiments, an optical transceiver includes: a receiver and a processor. The receiver receives a polarization multiplexed optical signal that includes a first polarization signal and a second polarization signal so as to output reception electric-field information that indicates an electric field of the polarization multiplexed optical signal. The processor calculates, according to the reception electric-field information, a variation monitor value that indicates an amount of leakage of signal components between the first polarization signal and the second polarization signal. When the variation monitor value exceeds a specified threshold, the processor analyzes, according to the reception electric-field information, a state of an optical transmission line through which the polarization multiplexed optical signal propagates.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an optical transmission system;

FIG. 2 illustrates an example of a receiver implemented in an optical transceiver;

FIGS. 3A and 3B illustrate a configuration example of an adaptive equalizer;

FIG. 4 illustrates an example of a method for deciding a received symbol;

FIGS. 5A-5C illustrate a variation of a method for calculating a variation monitor value;

FIG. 6 illustrates an example of a method for analyzing a fast polarization variation;

FIG. 7 illustrates examples of the functions of a polarization variation analyzer;

FIG. 8 illustrates an example of the circuit configuration of a variation monitor;

FIG. 9 illustrates an example of an optical transceiver in accordance with another embodiment of the invention; and

FIG. 10 illustrates an example of processing performed by an adaptive equalizer.

### DESCRIPTION OF EMBODIMENTS

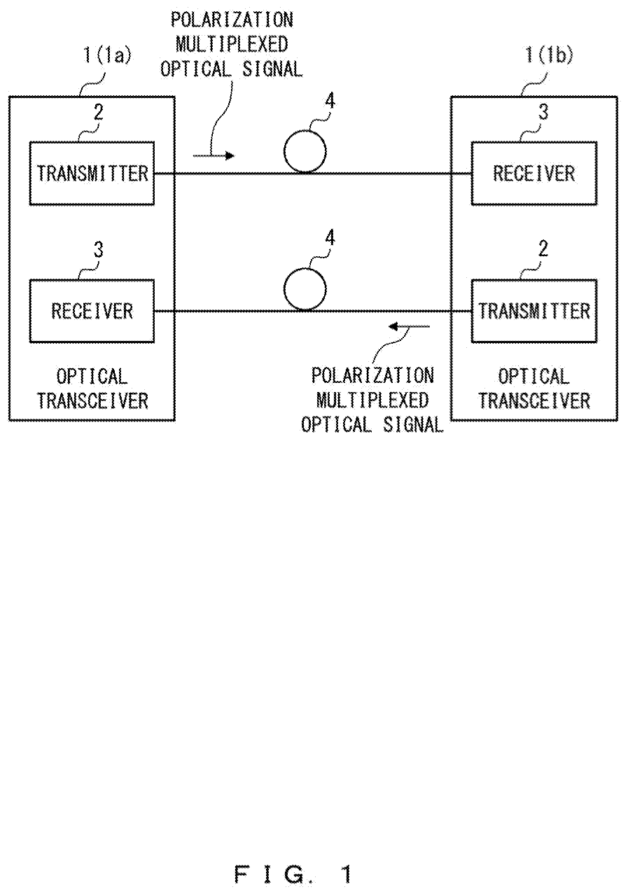

FIG. 1 illustrates an example of an optical transmission system in which optical transceivers in accordance with embodiments of the invention are used. In this optical transmission system, an optical signal is transmitted bidirectionally between an optical transceiver 1 (1a) and an optical transceiver 1 (1b).

Each optical transceiver 1 includes a transmitter and a receiver 3. The transmitter 2 generates a polarization multiplexed optical signal from input data. The polarization multiplexed optical signal carries two optical signals by using a pair of polarizations (X polarization and Y polarization) orthogonal to each other. Two optical signals multiplexed into a polarization multiplexed optical signal may hereinafter be referred to as a “X polarization signal” and a “Y polarization signal”. The polarization multiplexed optical signal propagates through an optical fiber transmission line 4. In particular, a polarization multiplexed optical signal generated by the optical transceiver 1a propagates to the optical transceiver 1b through the optical fiber transmission line 4. Similarly, a polarization multiplexed optical signal generated by the optical transceiver 1b propagates to the optical transceiver 1a through the optical fiber transmission line 4. The receiver 3 receives a polarization multiplexed optical signal transmitted from a correspondent node so as to recover data.

In the optical transmission system, each optical transceiver 1 has a function for monitoring and analyzing the state of the optical fiber transmission line 4. Specifically, the optical transceiver 1 has a function for monitoring and analyzing a polarization variation in the optical fiber transmission line 4.

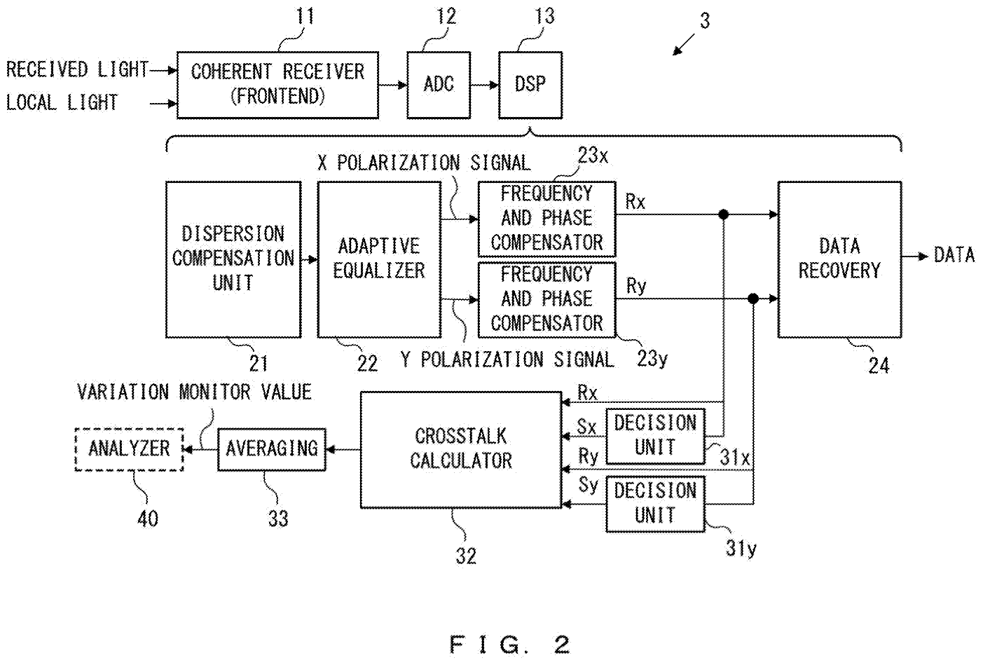

FIG. 2 illustrates an example of the receiver 3 implemented in the optical transceiver 1. In this example, the receiver 3 includes a coherent receiver 11, an analog-to-digital converter (ADC) 12, and a digital signal processor (DSP) 13. The receiver 3 may also include circuits or functions that are not depicted in FIG. 2.

Received light and local light are input to the coherent receiver 11. The received light is transmitted from a correspondent node, propagates through the optical fiber transmission line 4, and is input to the receiver 3. In this example, the received light includes a polarization multiplexed optical signal generated by the correspondent node. The local light is generated by a local light source (not illustrated). An optical frequency of the local light is substantially the same as an optical frequency of the received light (i.e., a carrier frequency of the polarization multiplexed optical signal).

The coherent receiver 11 includes a 90° optical hybrid circuit and an optical receiver circuit. The 90° optical hybrid circuit demultiplexes received light into rays of polarization light orthogonal to each other. Orthogonal polarizations obtained by the 90° optical hybrid circuit may hereinafter be referred to as a “H polarization” and a “V polarization”. The 90° optical hybrid circuit demultiplexes each ray of polarization light into an I (in-phase) component and a Q (quadrature) component by using local light. The optical receiver circuit converts each light component into an electric signal. Thus, the coherent receiver 11 generates electric signals indicating a HI component, HQ component, VI component, and VQ component of the received light. That is, the coherent receiver 11 generates electric field information indicating the received light.

The ADC 12 converts each electric-field-information signal generated by the coherent receiver 11 into a digital signal. The ADC 12 may parallelize and output the electric-field-information signals.

The DSP 13 recovers data from a digital signal (i.e., electric field information indicating received light) output from the ADC 12. The DSP 13 has a function for monitoring the state of the optical fiber transmission line according to electric field information indicating received light. For example, the DSP 13 may be implemented by a digital circuit that includes a logic circuit, a latch circuit, and the like. However, the DSP 13 may be implemented by a processor system that includes a processor and a memory. In this case, the processor may provide the function for recovering data and/or the function for monitoring the state of the optical fiber transmission line 4 by executing a communication program stored in the memory. Alternatively, the DSP 13 may be implemented by a digital circuit and a processor system.

As depicted in FIG. 2, the DSP 13 includes a dispersion compensation unit 21, an adaptive equalizer 22, a frequency and phase compensators 23x and 23y, a data recovery 24, decision units 31x and 31y, a crosstalk calculator 32, and an averaging unit 33. The DSP 13 may also have functions that are not depicted in FIG. 2.

The dispersion compensation unit 21 compensates for dispersion (e.g., chromatic dispersion) in the optical fiber transmission line 4. For example, the dispersion compensation unit 21 may be implemented by a digital filter such as an FIR filter. In this case, tap coefficients of the digital filter may be fixed values designed according to the length, material, and the like of the optical fiber transmission line 4.

The adaptive equalizer 22 equalizes output signals of the dispersion compensation unit 21. In particular, the adaptive equalizer 22 equalizes pieces of electric field information (HI, HQ, VI, VQ) in which dispersion has been compensated for. In this case, the adaptive equalizer 22 demultiplexes the X polarization component and the Y polarization component of the polarization multiplexed optical signal. That is, the adaptive equalizer 22 extracts the X polarization component and the Y polarization component from the polarization multiplexed optical signal.

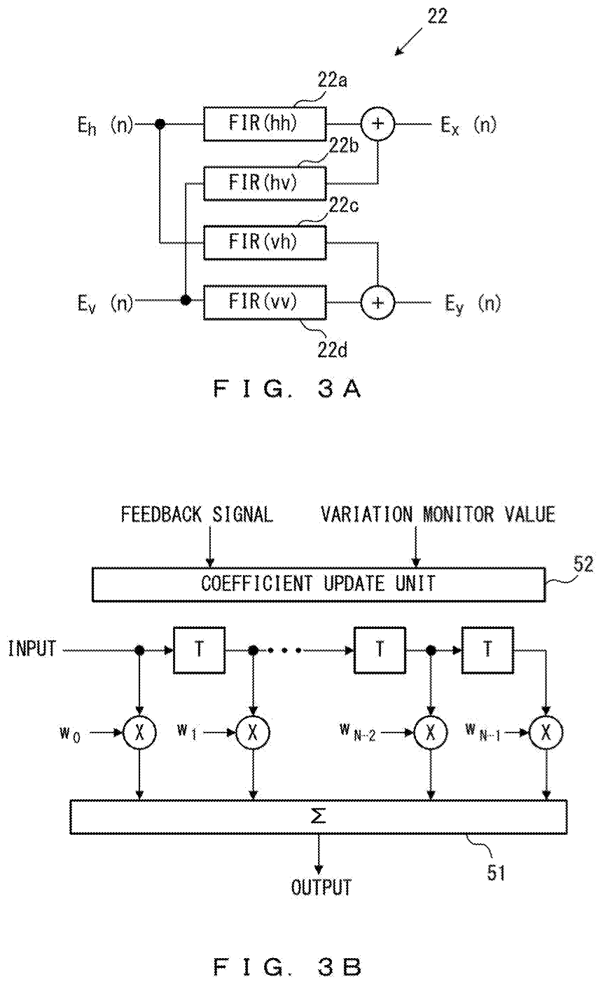

For example, the adaptive equalizer 22 may be implemented by a butterfly-type digital filter circuit that includes a plurality of FIR filters, as depicted in FIG. 3A. In this example, the adaptive equalizer 22 includes four FIR filters 22a-22d. A signal Eₕ (n) indicating H polarization components is input to the FIR filters 22a and 22c. A signal Eᵥ(n) indicating V polarization components is input to the FIR filters 22b and 22d. A X polarization signal Eₓ (n) is obtained by adding an output signal of the FIR filter 22b to an output signal of the FIR filter 22a. Similarly, a Y polarization signal E_{y} (n) is obtained by adding an output signal of the FIR filter 22c to an output signal of the FIR filter 22d.

FIG. 3B illustrates an example of each of the FIR filters of the butterfly-type digital filter circuit. In this example, the FIR filter includes tap circuits T for holding an input signal, multipliers each for multiplying an input signal or a signal held by a corresponding tap circuit T by a tap coefficient w, and a summation circuit (Σ) 51 for calculating the total sum of output signals of the multipliers. Tap coefficients W₀ to W_{N-1} are updated by a coefficient update unit 52. The coefficient update unit 52 updates the tap coefficients W₀ to W_{N-1} through feedback control using an output signal of the adaptive equalizer 22. As an example, the tap coefficients of the FIR filters 22a and 22b may be updated according to an output signal Eₓ(n) depicted in FIG. 3A, and the tap coefficients of the FIR filters 22c and 22d may be updated according to an output signal E_{y} (n).

The tap coefficients of each FIR filter are adaptively adjusted. For example, when the state of the optical fiber transmission line 4 is changed and the waveform of an output signal of the adaptive equalizer 22 is changed, the tap coefficients of each FIR filter may be adaptively adjusted in accordance with the waveform change. As an example, the tap coefficients of each FIR filter may be adaptively adjusted to bring the amplitude of the output signal of the adaptive equalizer 22 close to a specified target value.

As described above, the tap coefficients of the FIR filters of the adaptive equalizer 22 are adaptively adjusted in accordance with the state of the optical fiber transmission line 4. Hence, the state of the optical fiber transmission line 4 can be monitored according to the tap coefficients of the FIR filters. A method for calculating the polarization state in an optical fiber transmission line according to the tap coefficients of FIR filters is described in, for example, the above-indicated document Boitier et al.

The frequency and phase compensator 23x compensates for a frequency offset of a X polarization signal output from the adaptive equalizer 22. The frequency offset indicates a difference between the carrier frequency of a polarization multiplexed optical signal and the frequency of local light. The frequency and phase compensator 23x further compensates for a phase rotation that occurs in the optical fiber transmission line 4. In particular, the frequency and phase compensator 23x calculates, for each symbol, reception electric-field information Rx of a X polarization signal. The reception electric-field information Rx indicates the phase and amplitude of a received symbol that is transmitted using the X polarization from the transmitter 2 of a correspondent node.

The frequency and phase compensator 23y compensates for a frequency offset of a Y polarization signal output from the adaptive equalizer 22. The frequency and phase compensator 23y further compensates for a phase rotation that occurs in the optical fiber transmission line 4. In particular, the frequency and phase compensator 23Y calculates, for each symbol, reception electric-field information Ry of a Y polarization signal. The reception electric-field information Ry indicates the phase and amplitude of a received symbol that is transmitted using the Y polarization from the transmitter 2 of a correspondent node.

By deciding the symbols of the X polarization signal according to the reception electric-field information Rx, the data recovery 24 recovers the data transmitted from the correspondent node by using the X polarization. Similarly, by deciding the symbols of the Y polarization signal according to the reception electric-field information Ry, the data recovery 24 recovers the data transmitted from the correspondent node by using the Y polarization. The data recovery 24 may have a function for correcting an error in the recovered data.

The dispersion compensation unit 21, the adaptive equalizer 22, the frequency and phase compensators 23x and 23y, and the data recovery 24 are operated in synchrony with a clock of the DSP 13. Thus, when the clock is slow in comparison with the symbol rate of the polarization multiplexed optical signal, the DPS 13 may recover data through parallel processing. In this case, the ADC 12 outputs parallelized electric-field-information signals, and the dispersion compensation unit 21, the adaptive equalizer 22, the frequency and phase compensator 23x and 23y, and the data recovery 24 recover data through parallel processing.

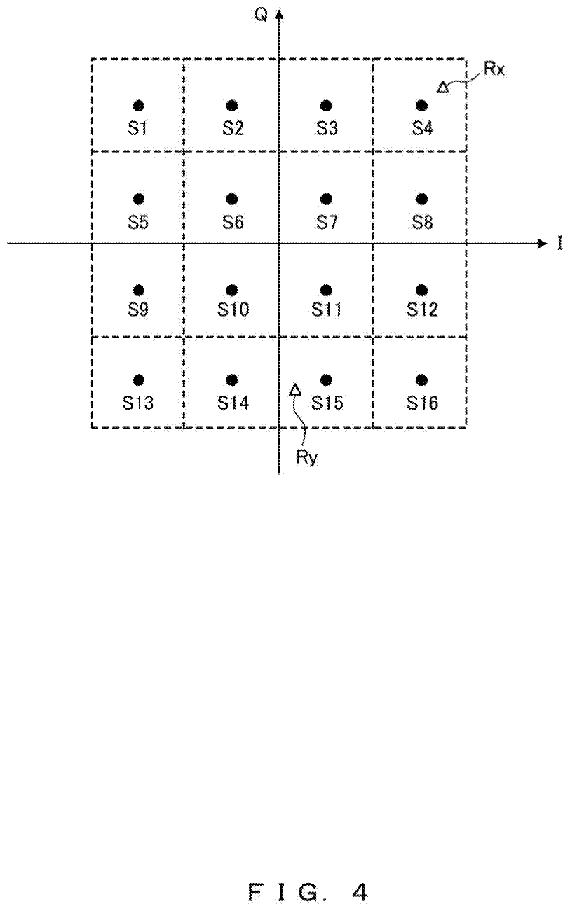

The decision unit 31x decides a corresponding symbol according to reception electric-field information Rx. For example, when the modulation scheme is 16QAM, data may be transmitted according to a constellation depicted in FIG. 4. In this case, every 4-bit data is assigned to corresponding symbols S1-S16 and transmitted. The decision unit 31x decides a symbol that corresponds to reception electric-field information Rx by specifying a symbol located closest to reception electric-field information Rx on an I-Q plane. In the example depicted in FIG. 4, the decision unit 31x determines that the data has been transmitted using the symbol S4. Note that the phases and amplitudes of the symbols S1-S16 are known.

Similarly, the decision unit 31y decides a corresponding symbol according to reception electric-field information Ry. In the example depicted in FIG. 4, the decision unit 31y determines that the data has been transmitted using the symbol S15.

The crosstalk calculator 32 may calculate, for each symbol, crosstalk between a X polarization signal and a Y polarization signal. In particular, the crosstalk calculator 32 calculates the amount of leakage of signal components between the X polarization signal and the Y polarization signal. The crosstalk calculator 32 calculates a variation monitor value XT by using formula (1). The variation monitor value XT indicates the amount of leakage of signal components between the X polarization signal and the Y polarization signal.

$$XT = \frac{\vert ( Rx - Sx ) / Sy \vert + \vert ( Ry - Sy ) / Sx \vert}{2} \qquad ( 1 )$$

Sx indicates electric field information of a symbol decided according to reception electric-field information Rx. Sy indicates electric field information of a symbol decided according to reception electric-field information Ry.

The first term of the numerator in the right side of formula (1) indicates the amount of signal components leaked from the Y polarization signal into the X polarization signal. In the example depicted in FIG. 4, “Rx-Sx” corresponds to the distance between Rx and S4 on the I-Q plane, and Sy corresponds to, for example, the amplitude of the symbol Sy (i.e., the distance between the origin of the I-Q plane and S15). The second term of the numerator in the right side of formula (1) indicates the amount of signal components leaked from the X polarization signal into the Y polarization signal. In the example depicted in FIG. 4, “Ry-Sy” corresponds to the distance between Ry and S15 on the I-Q plane, and Sx corresponds to, for example, the amplitude of the symbol Sx (i.e., the distance between the origin of the I-Q plane and S4).

The averaging unit 33 calculates the average of variation monitor values XT calculated by the crosstalk calculator 32. The averaging is performed in a time domain. As an example, the averaging unit 33 may perform the averaging for several to tens of symbols. The averaging unit 33 is provided to reduce errors in variation monitor values XT and is not an essential component. Thus, the variation monitor value XT may indicate a value calculated by the crosstalk calculator 32 or an average value calculated by the averaging unit 33.

As described above, the variation monitor value XT indicates the magnitude of crosstalk between the X polarization signal and the Y polarization signal (i.e., the amount of leakage of signal components between the X polarization signal and the Y polarization signal). Assume that the dispersion compensation unit 21 can accurately compensate for dispersion and that the frequency and phase compensators 23x and 23y can accurately compensate for a frequency offset and a phase rotation. In this case, when the state of the optical fiber transmission line 4 is stable, it is considered that “Rx-Sx” and “Ry-Sy” in formula (1) are small and the variation monitor value XT is also small.

When the state of the optical fiber transmission line 4 (the state of a polarization in this example) is changed, the adaptive equalizer 22 compensates for the change. In this case, the tap coefficients of the digital filters of the adaptive equalizer 22 are adjusted. However, when a fast polarization variation has occurred, “Rx−Sx” and/or “Ry−Sy” in formula (1) become instantly large and the variation monitor value MT also becomes large until the tap coefficients of the adaptive equalizer 22 are properly adjusted.

As described above, the variation monitor value XT becomes large when a fast polarization variation occurs in the optical fiber transmission line 4. Hence, a fast polarization variation can be sensed by calculating the variation monitor value XT. However, the variation monitor value XT may become large due to factors other than a polarization variation. Accordingly, when the variation monitor value XT exceeds a specified threshold, the DSP 13 determines that a fast polarization variation has the likelihood of having occurred in the optical fiber transmission line 4.

An analyzer 40 is activated when it is determined that a fast polarization variation has the likelihood of having occurred. The analyzer 40 analyzes the state of the optical fiber transmission line 4 according to reception electric-field information, as will be described hereinafter.

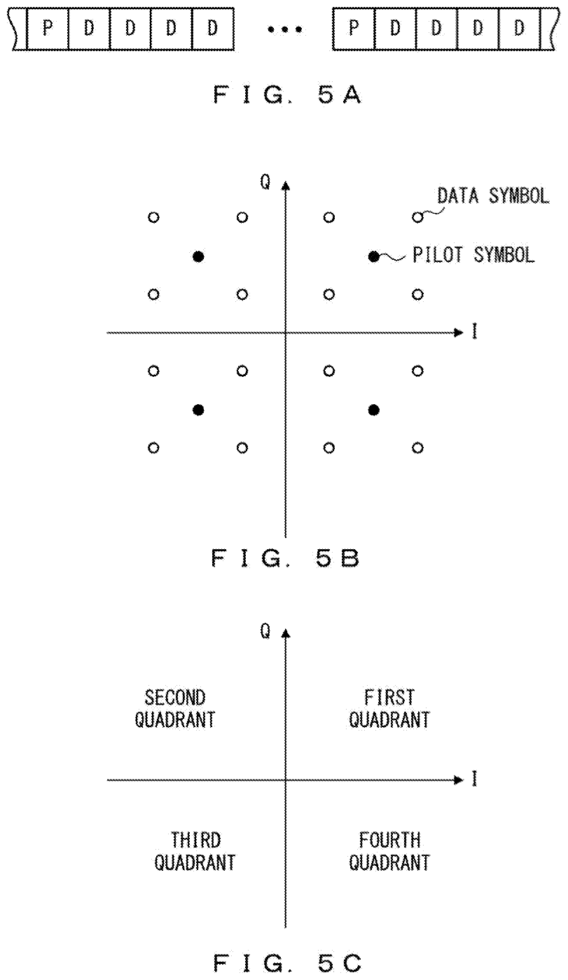

The following indicates a variation of the method for calculating a variation monitor value. In the example depicted in FIGS. 5A-5B, crosstalk between polarizations is calculated using only pilot symbols. The pilot symbols are added to transmission signals at specified time intervals. In FIG. 5A, P indicates a pilot symbol, and D indicates a data symbol. The modulation level of each pilot symbol is lower than that of the data symbols. For example, when the modulation scheme for the data symbols is 16QAM, the modulation scheme for the pilot symbols may be QPSK. The modulation level indicates the number of bits assigned to each symbol. Note that the modulation scheme for pilot signals is determined in advance in many cases.

Accordingly, the amount of calculation is decreased when obtaining a variation monitor value by using symbols with a low modulation level. For example, the amount of calculation performed by the decision units 31x and 31y may be decreased. Obtaining a variation monitor value by using symbols with a modulation scheme determined in advance allows the configuration of the calculation circuit to be simplified. For example, in a configuration in which a variation monitor value is calculated using data symbols, the configurations of the decision units 31x and 31y could be complicated if data is transmitted using a modulation scheme dynamically selected from a plurality of modulation schemes.

In the example depicted in FIG. 5C, the decision units 31x and 31y respectively determine which quadrant received symbols indicated by reception electric-field information Rx and Ry belong to. The crosstalk calculator 32 calculates a variation monitor value according to reception electric-field information Rx and Ry and the results of determinations performed by the decision units 31x and 31y.

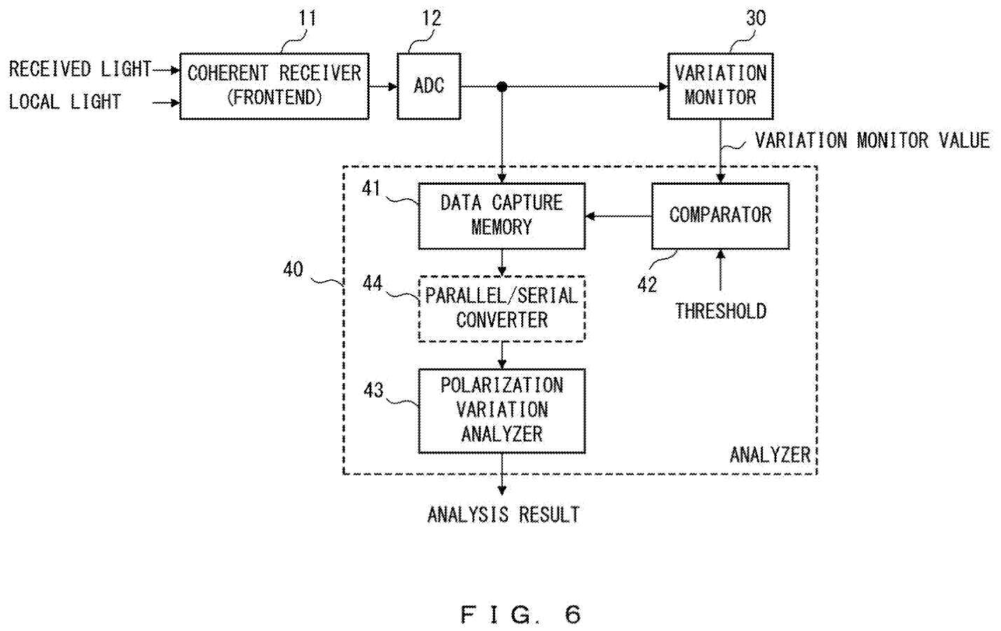

FIG. 6 illustrates an example of a method for analyzing a fast polarization variation. In this example, to analyze a fast polarization variation, the optical transceiver 1 includes a variation monitor 30, a data capture memory 41, a comparator 42, and a polarization variation analyzer 43. The variation monitor 30 corresponds to the decision units 31x and 31y, the crosstalk calculator 32, and the averaging unit 33 depicted in FIG. 2. The data capture memory 41, the comparator 42, and the polarization variation analyzer 43 correspond to the analyzer 40 depicted in FIG. 2.

The variation monitor 30 calculates the above-described variation monitor value according to electric field information indicating a polarization multiplexed optical signal received by the optical transceiver 1. Although not illustrated in FIG. 6, the dispersion compensation unit 21, the adaptive equalizer 22, and the frequency and phase compensators 23x and 23y depicted in FIG. 2 are preferably provided between the ADC 12 and the variation monitor 30.

The data capture memory 41 stores, on the time series, pieces of electric field information (HI components, HQ components, VI components, VQ components) indicating the polarization multiplexed optical signal received by the optical transceiver 1. However, pieces of electric field information in the data capture memory 41 are overwritten with pieces of newly generated electric field information starting from the piece of oldest electric field information. Thus, the data capture memory 41 stores a specified amount of latest reception electric-field information. In this example, the data capture memory 41 stores as much reception electric-field information as is needed for the polarization variation analyzer 43 to analyze a fast polarization variation.

The comparator 42 compares, all the time, a latest variation monitor value generated by the variation monitor 30 with a specified threshold. When detecting that the variation monitor value is larger than the threshold, the comparator 42 generates and gives a capture instruction to the data capture memory 41. Upon the capture instruction being generated, the electric field information stored in the data capture memory 41 at that time is captured. The electric field information captured by the data capture memory 41 is forwarded to the polarization variation analyzer 43.

Increasing the threshold used by the comparator 42 makes a capture instruction less likely to be generated. Thus, when the threshold is excessively large, no electric field information may be captured by the data capture memory 41 even when a fast polarization variation has occurred in the optical fiber transmission line 4. By contrast, decreasing the threshold makes a capture instruction more likely to be generated. Thus, when the threshold is excessively small, electric field information may be captured by the data capture memory 41 even when a fast polarization variation has not occurred in the optical fiber transmission line 4. Accordingly, the threshold is preferably designed in consideration of, for example, “the degree of polarization variations to be analyzed”.

The polarization variation analyzer 43 analyzes the polarization variation in the optical fiber transmission line 4 according to the electric field information captured by the data capture memory 41. The polarization variation analyzer 43 may be implemented using, but not particularly limited to, a publicly known technique. For example, the polarization variation analyzer 43 may include digital filters for equalizing reception electric-field information and calculate parameters indicating a polarization state using the tap coefficients of the digital filters. In this case, the polarization variation analyzer 43 may have an equivalent function to the adaptive equalizer depicted in FIG. 2 and perform the Jones to Stokes conversion of the tap coefficient vectors of the FIR filters of the adaptive equalizer, thereby calculating parameters s0, s1, s2, and s3 indicating the polarization state; and the polarization variation analyzer 43 may calculate a variation in the polarization in accordance with a change in the parameters indicating the polarization state. A method for calculating parameters s0, s1, s2, and s3 according to the tap coefficient vectors of the FIR filters is described in, for example, the above-indicated document Boitier et al.

However, since the result of processing performed by the polarization variation analyzer 43 is not used for data recovery, the polarization variation analyzer 43 does not necessarily need to perform real-time processing. Hence, the polarization variation analyzer 43 may slowly analyze the polarization state by using the electric field information captured by the data capture memory 41. In this case, the polarization variation analyzer 43 may be implemented by a low-operation-speed processor.

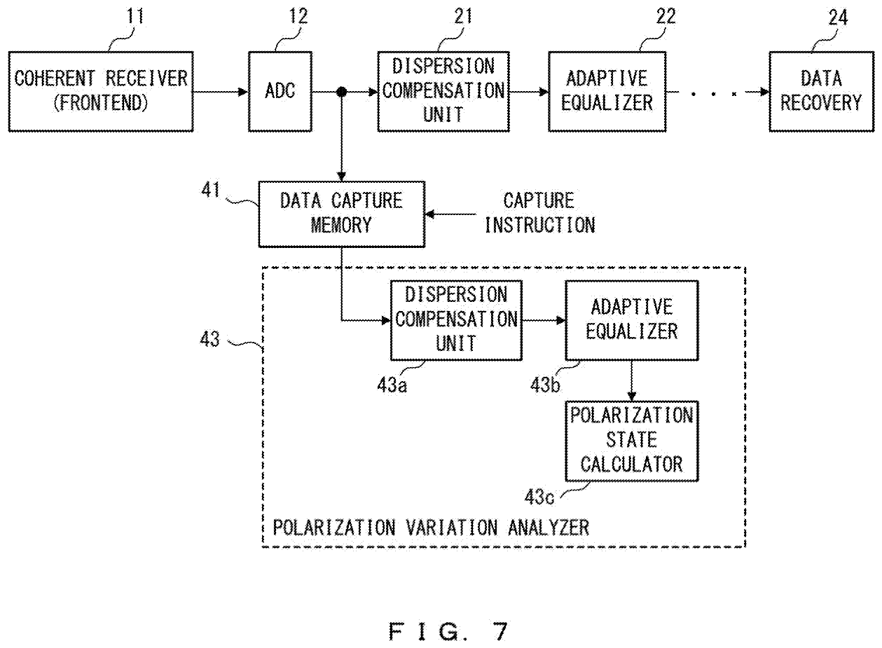

FIG. 7 illustrates examples of the functions of the polarization variation analyzer 43. The polarization variation analyzer 43 includes a dispersion compensation unit 43a, an adaptive equalizer 43b, and a polarization state calculator 43c. The functions of the dispersion compensation unit 43a and the adaptive equalizer 43b are substantially the same as those of the dispersion compensation unit 21 and the adaptive equalizer 22, respectively. Thus, the dispersion compensation unit 43a compensates for dispersion (e.g., chromatic dispersion) in the optical fiber transmission line 4. The adaptive equalizer 43b equalizes output signals of the dispersion compensation unit 43a and extracts X polarization signal and Y polarization signal from a polarization multiplexed optical signal.

The adaptive equalizer 43b may include the butterfly-type digital filter circuit depicted in FIG. 3A. The tap coefficients of the FIR filters are updated through feedback control. The polarization state calculator 43c calculates the polarization state in the optical fiber transmission line 4 by using the tap coefficients of the adaptive equalizer 43b.

As described above, the function of the adaptive equalizer 43b is substantially the same as that of the adaptive equalizer 22. Hence, the polarization state in the optical fiber transmission line 4 can be calculated using the tap coefficients of the adaptive equalizer 22. However, the adaptive equalizer 22 needs to have a high followability for a change in an input signal so as to monitor a fast polarization variation. Increasing the followability of the adaptive equalizer 22, however, will deteriorate the characteristics of main signals (i.e., signals guided to the data recovery 24). Thus, the adaptive equalizer 22 having a high followability is not preferable when the polarization in the optical fiber transmission line 4 is stable.

Accordingly, the optical transceiver 1 includes the polarization variation analyzer 43 to monitor a fast polarization variation. The adaptive equalizer 43b performs an equalization process with a sufficiently high followability for a change in an input signal. This configuration allows a fast polarization variation to be accurately monitored without deteriorating the characteristics of main signals.

As described above, the polarization variation analyzer 43 calculates the polarization state by using electric field information captured by the data capture memory 41. Thus, the followability of the adaptive equalizer 43b for a change in an input signal can be easily increased by allowing electric field information to be slowly supplied from the data capture memory 41 to the adaptive equalizer 43b. Accordingly, a fast polarization variation is accurately monitored even if the processing speed of the polarization variation analyzer 43 is not high.

In a method for monitoring a variation in a polarization in accordance with embodiments of the invention, reception electric-field information is captured when the variation monitor value exceeds a threshold. The polarization variation analyzer 43 calculates a polarization variation in the optical fiber transmission line 4 according to the reception electric-field information that has been captured. In particular, the polarization variation analyzer 43 calculates a polarization variation in the optical fiber transmission line 4 when the variation monitor value exceeds the threshold.

The variation monitor value is considered to be increased when the state of the optical fiber transmission line 4 is instantly changed, as described above by referring to FIG. 2. Thus, an instant change in the state of the optical fiber transmission line 4 can be detected by monitoring a timing at which the variation monitor value exceeds the threshold. Accordingly, the method for monitoring a variation in a polarization in accordance with embodiments of the invention allows occurrence of a fast polarization variation, which occurs with low frequency, to be reliably detected. The analyzer 40 does not monitor a polarization variation all the time but monitors such a variation only when the variation monitor value exceeds a threshold, thereby realizing efficient polarization analysis.

Processing capacities of the dispersion compensation unit 21, the adaptive equalizer 22, and the frequency and phase compensators 23x and 23y depicted in FIG. are dependent on the clock frequency of the DSP 13. However, speed-enhancement of the clock frequency of the DSP 13 is limited. Thus, in this example, electric-field-information signals forwarded from the ADC 12 to the DSP 13 are parallelized. For example, the ADC 12 may output 128-bit parallel data.

When the ADC 12 outputs parallelized electric-field-information signals, the data capture memory 41 stores these signals in a parallelized state. However, pieces of reception electric-field information output from the coherent receiver 11 need to be sequentially used to accurately analyze a polarization variation. Thus, in this case, a parallel/serial converter 44 is provided between the data capture memory 41 and the polarization variation analyzer 43, as depicted in FIG. 6. The parallel/serial converter 44 converts electric-field-information signals in a parallel format that are read from the data capture memory 41 into electric-field-information signals in a serial format. The polarization variation analyzer 43 performs adaptive equalization processing of the electric-field-information signals in the serial format and analyzes the polarization state in the optical fiber transmission line 4 by using the tap coefficients or the like updated through the processing.

As the result of processing performed by the polarization variation analyzer 43 is not used for data recovery, the polarization variation analyzer 43 does not necessarily need to perform real-time processing. Thus, the polarization variation analyzer 43 can sequentially process pieces of reception electric-field information output from the coherent receiver 11 even when the processing speed of the polarization variation analyzer 43 is low in comparison with the symbol rate of polarization multiplexed optical signals. Hence, the polarization variation analyzer 4 can accurately analyze a fast polarization variation.

Variations

Various variations are possible as configurations for realizing analysis of a fast polarization variation. For example, the polarization variation analyzer 43 may be provided outside the optical transceiver 1. In this case, when a variation monitor value exceeds a threshold, the optical transceiver 1 outputs electric field information captured by the data capture memory 41. The polarization variation analyzer 43 analyzes the state of a polarization in the optical fiber transmission line 4 by using the electric field information output from the optical transceiver 1. For example, the analyzing of a polarization state may be implemented by a software program.

Functions of the comparator 42 and the polarization variation analyzer 43 may be implemented by a software program. In this case, this software program includes a comparison function for comparing a variation monitor value with a threshold, an acquisition function for acquiring electric field information stored in the data capture memory 41 when the variation monitor value exceeds the threshold, and an analysis function for analyzing the state of a polarization by using the acquired electric field information.

In addition, functions of the variation monitor 30, the comparator 42, and the polarization variation analyzer 43 may be implemented by a software program. In this case, this software program includes a function for calculating the variation monitor value in addition to the comparison function, the acquisition function, and the analysis function described above.

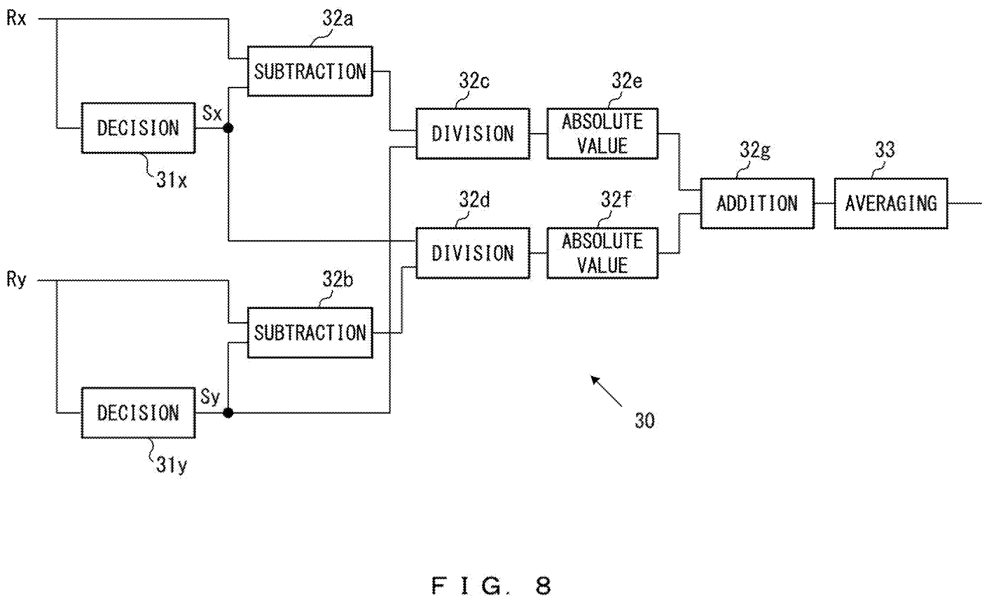

Meanwhile, the variation monitor 30 may be implemented by a digital circuit, as depicted in FIG. 8. In this example, the decision unit 31x may compare I component and Q component of reception electric-field information Rx with a plurality of thresholds depending on a modulation scheme so as to decide a symbol that corresponds to reception electric-field information Rx, thereby acquiring symbol information Sx. Similarly, the decision unit 31y may compare I component and Q component of reception electric-field information Ry with a plurality of thresholds depending on a modulation scheme so as to decide a symbol that corresponds to reception electric-field information Ry, thereby acquiring symbol information Sy.

A subtraction circuit 32a calculates a difference between reception electric-field information Rx and symbol information Sx. A subtraction circuit 32b calculates a difference between reception electric-field information Ry and symbol information Sy. A division circuit 32c divides the difference obtained by the subtraction circuit 32a by symbol information Sy. A division circuit 32d divides the difference obtained by the subtraction circuit 32b by symbol information Sx. The division circuits 32c and 32d may respectively perform the divisions using the absolute values of symbol information Sy and Sx. An absolute value circuit 32e calculates the absolute value of an output signal of the division circuit 32c. An absolute value circuit 32f calculates the absolute value of an output signal of the division circuit 32d. An addition circuit 32g sums the output signals of the absolute value circuits 32e and 32f. The addition circuit 32g may divide this sum by two. The averaging unit 33 calculates the average of output signals of the addition circuit 32.

### Another Embodiment

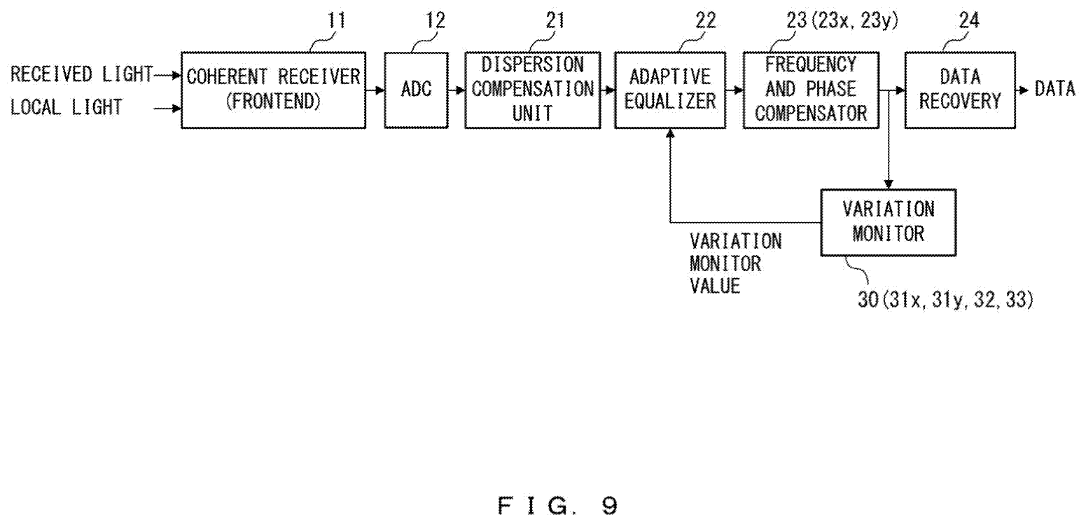

FIG. 9 illustrates an example of an optical transceiver in accordance with another embodiment of the invention. Note that components for transmitting an optical signal are not depicted in FIG. 9.

In the other embodiment, the optical transceiver 1 includes the coherent receiver 11, the ADC 12, the dispersion compensation unit 21, the adaptive equalizer 22, a frequency and phase compensator 23, the data recovery 24, and the variation monitor 30, as depicted in FIG. 9. The frequency and phase compensator 23 corresponds to the frequency and phase compensators 23x and 23y depicted in FIG. 2. The variation monitor 30 may be implemented by the decision units 31x and 31y, the crosstalk calculator 32, and the averaging unit 33 depicted in FIG. 2.

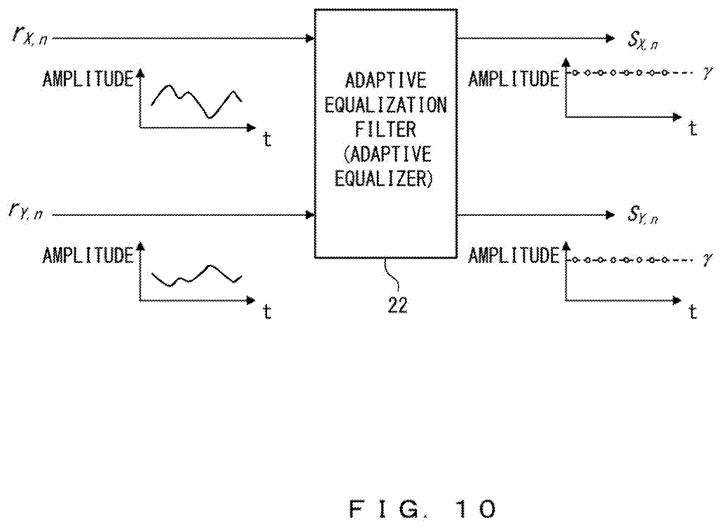

The adaptive equalizer 22 is implemented by an adaptive equalization filter, as depicted in FIG. 10. The adaptive equalization filter is implemented by a butterfly-type filter circuit that includes four FIR filters (hh, hv, vh, vv), as depicted in FIGS. 3A and 3B. The tap coefficients of each FIR filter are adaptively adjusted by a feedback system that uses an output signal of the adaptive equalizer 22.

Signals r_{X,n}, and r_{Y,n} indicating electric field information of light (i.e., a polarization multiplexed optical signal) received by the optical transceiver 1 are input to the adaptive equalization filter. The adaptive equalization filter performs filtering processing for r_{X,n} and r_{Y,n} so as to output signals S_{X,n} and S_{Y,n}. The tap coefficients of each FIR filter are updated in accordance with, for example, formula (2). In particular, the tap coefficients of each FIR filter are updated using a maximum gradient descent method relying on the constant modulus algorithm (CMA). The updating of the tap coefficients of each FIR filter is not particularly limited to a certain technique and may be implemented using another publicly known adaptive-equalization processing technique.

wₙ₊₁=wₙ−μrₙ*(|sₙ|²−γ)sₙ (2)

Wₙ indicates a coefficient vector (Wₕₕ, W_{hy}, Wᵥₕ Wᵥᵥ) of the adaptive equalization filter at time n. In the example depicted in FIGS. 3A and 3B, Wₕₕ, Wₕᵥ, Wᵥₕ, and Wᵥᵥ respectively indicate tap coefficients given to the FIR filters 22a, 22b, 22c, and 22d. rₙ indicates an input signal (r_{X,n}, r_{Y,n}) of the adaptive equalization filter at time n. Sₙ indicates an output signal (S_{X,n}, S_{Y,n}) of the adaptive equalization filter at time n. The sign * indicates a complex conjugate. μ indicates a step size. γ indicates a target signal amplitude.

In this method, the coefficient update unit 52 depicted in FIG. 3B updates the tap coefficients of each FIR filter so as to bring the amplitude of the output signal close to γ. The followability of the adaptive equalizer 22 for a change in the input signal is dependent on the step size μ. In particular, increasing the step size μ enhances the followability for a variation in the input amplitude. However, noise tolerance is reduced when the step size μ is excessively large. By contrast, decreasing the step size μ heightens noise tolerance. However, the followability for a variation in the input amplitude is reduced when the step size μ is excessively small.

Accordingly, in the other embodiment, the step size μ is determined in accordance with the state of the polarization in the optical fiber transmission line 4. A variation in the polarization in the optical fiber transmission line 4 results in a change in the variation monitor value calculated by the variation monitor 30. Thus, the step size μ is adjusted in accordance with the variation monitor value.

For example, when a large polarization variation has occurred in the optical fiber transmission line 4, an amplitude balance between the X polarization signal and Y polarization signal may be lost, thereby increasing the variation monitor value. In this case, the adaptive equalizer 22 preferably immediately brings the amplitude variation close to the target amplitude through strong feedback control. Thus, when a large polarization variation has occurred, the step size μ is preferably increased to enhance a rate of update of the tap coefficients of the adaptive equalization filter.

On the other hand, the variation monitor value is small when the polarization in the optical fiber transmission line 4 is stable. In this case, the adaptive equalizer 22 preferably slowly brings the amplitude variation close to the target amplitude through weak feedback control so as to heighten noise tolerance. Thus, when the polarization is stable, the step size μ is preferably decreased to reduce the rate of update of the tap coefficients of the adaptive equalization filter.

Accordingly, the step size μ is dynamically determined in accordance with the variation monitor value XT, as indicated in, for example, formula (3).

μ=fixed value+variation monitor value XT×adjustment factor (3)

Note that the adjustment factor is a constant.

For example, the step size μ may be calculated by the coefficient update unit 52 depicted in FIG. 3B. In this case, the variation monitor value XT calculated by the variation monitor 30 is reported to the coefficient update unit 52. The coefficient update unit 52 calculates the step size μ in accordance with formula (3). Note that the step size μ is an example of a control parameter for controlling the processing performed by the adaptive equalizer 22.

Accordingly, in the other embodiment, the rate of update of the filter coefficients of the adaptive equalizer 22 is adjusted in accordance with the state of the polarization in the optical fiber transmission line 4. Thus, the noise tolerance and the performance of following a polarization variation are implemented in a balanced manner in accordance with the state of the polarization in the optical fiber transmission line 4.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An optical transceiver comprising:
a receiver configured to receive a polarization multiplexed optical signal that includes a first polarization signal and a second polarization signal so as to output reception electric-field information that indicates an electric field of the polarization multiplexed optical signal; and
a processor configured to
calculate, according to the reception electric-field information, a variation monitor value that indicates an amount of leakage of signal components between the first polarization signal and the second polarization signal, and
analyze, according to the reception electric-field information, a state of an optical transmission line through which the polarization multiplexed optical signal propagates when the variation monitor value exceeds a specified threshold.

2. The optical transceiver according to claim 1, wherein
the processor generates, according to the reception electric-field information, first reception electric-field information indicating an electric field of the first polarization signal and second reception electric-field information indicating an electric field of the second polarization signal, and
the processor calculates the variation monitor value according to the first reception electric-field information, first symbol information indicating an electric field of a first symbol obtained by deciding a symbol that corresponds to the first reception electric-field information, the second reception electric-field information, and second symbol information indicating an electric field of a second symbol obtained by deciding a symbol that corresponds to the second reception electric-field information.

3. The optical transceiver according to claim 2, wherein
the processor calculates the variation monitor value according to a sum of a value obtained by dividing a difference between the first reception electric-field information and the first symbol information by the second symbol information and a value obtained by dividing a difference between the second reception electric-field information and the second symbol information by the first symbol information.

4. The optical transceiver according to claim 1, further comprising:
a capture unit configured to capture the reception electric-field information when the variation monitor value exceeds the threshold, wherein
the processor analyzes the state of the optical transmission line according to the reception electric-field information captured by the capture unit.

5. The optical transceiver according to claim 4, wherein
the capture unit includes a memory that stores a specified amount of latest reception electric-field information, and
the processor analyzes the state of the optical transmission line according to the reception electric-field information stored in the memory when the variation monitor value exceeds the threshold.

6. The optical transceiver according to claim 1, further comprising:
a memory configured to store the reception electric-field information; and
a parallel/serial converter, wherein
the reception electric-field information is stored in the memory in a parallelized state,
the parallel/serial converter converts the reception electric-field information read from the memory into reception electric-field information in a serial format, and
the processor analyzes the state of the optical transmission line according to the reception electric-field information in the serial format.

7. The optical transceiver according to claim 1, wherein
the processor generates, according to the reception electric-field information, first reception electric-field information indicating an electric field of the first polarization signal and second reception electric-field information indicating an electric field of the second polarization signal, and
a control parameter for controlling a process of the processor generating the first reception electric-field information and the second reception electric-field information is changed according to the variation monitor value.

8. The optical transceiver according to claim 7, wherein
the control parameter indicates a followability of the processor for a change in an input signal.

9. A method for monitoring a variation in a polarization, the method comprising:
receiving a polarization multiplexed optical signal that includes a first polarization signal and a second polarization signal;
generating reception electric-field information indicating an electric field of the polarization multiplexed optical signal;
calculating, according to the reception electric-field information, a variation monitor value that indicates an amount of leakage of signal components between the first polarization signal and the second polarization signal; and
analyzing, according to the reception electric-field information, a variation in a polarization state in an optical transmission line through which the polarization multiplexed optical signal propagates when the variation monitor value exceeds a specified threshold.

10. A non-transitory computer-readable recording medium having stored therein a program for causing a processor to execute a process, the process comprising:
comparing a variation monitor value with a specified threshold, the variation monitor value being calculated by an optical transceiver that receives a polarization multiplexed optical signal including a first polarization signal and a second polarization signal according to reception electric-field information indicating an electric field of the polarization multiplexed optical signal, the variation monitor value indicating an amount of leakage of signal components between the first polarization signal and the second polarization signal; and
analyzing, according to the reception electric-field information, a state of an optical transmission line through which the polarization multiplexed optical signal propagates when the variation monitor value exceeds the threshold.

11. A non-transitory computer-readable recording medium having stored therein a program for causing a processor to execute a process, the processor being implemented in an optical transceiver that receives a polarization multiplexed optical signal including a first polarization signal and a second polarization signal, the process comprising:
calculating, according to reception electric-field information indicating an electric field of the polarization multiplexed optical signal, a variation monitor value that indicates an amount of leakage of signal components between the first polarization signal and the second polarization signal; and
analyzing, according to the reception electric-field information, a state of an optical transmission line through which the polarization multiplexed optical signal propagates when the variation monitor value exceeds a specified threshold.
